(19) United States
(12) Patent Application Publication
(10) Pub. No.: US 2025/0331560 A1
(43) Pub. Date: Oct. 30, 2025

(54) Cartridge With Enhanced Energy Conduction and Oil Containment

(71) Applicant: Justin Cifelli, Scottsdale, AZ (US)

(72) Inventor: Justin Cifelli, Scottsdale, AZ (US)

(21) Appl. No.: 18/650,557

(22) Filed: Apr. 30, 2024

(51) Int. Cl. A24F 40/42; A24F 40/10; A24F 40/46; H05B 3/42

(52) U.S. Cl. CPC A24F 40/42; A24F 40/10; A24F 40/46; H05B 3/42

(57) ABSTRACT

A cartridge for a handheld atomizer device comprises at least a glass-coated silver conductive element, a beveled glass washer connected to the glass-coated silver conductive element, and an overflow containment storage tank for capturing any oil leaking from the tank holding the oil. In at least one preferred embodiment of the present invention, the conductive element is a glass coated silver bolt, the containment structure is a beveled glass washer, and the liquid substance is an oil. The handheld device can be used in conjunction with a standard vape pen for vaping various oils, including cannabis and tobacco products.

### BACKGROUND OF THE INVENTION

### 1. Technical Field

The present invention relates generally to the consumption of liquids such as “e-juice” or various oils using handheld devices and more particularly relates to a handheld atomizer for vaping oils contained in cartridges.

### 2. Background Art

Vape pens are becoming increasingly popular, and they come in a variety of shapes, sizes, and styles. A vape pen is simply a handheld device with an energy source that is configured to vaporize various substances for inhalation by the user. Vape pens typically consist of a battery, a heating element, and a cartridge or tank that holds the substance being vaporized.

Initially, vape pens were used for nicotine vaping, where nicotine is a substance found in tobacco. Today, vape pens are primarily used in conjunction with pre-filled cartridges containing various oils and extracts. Due to their versatility, vape pens can be utilized with a variety of atomizers that allow the user to “vape” or consume various substances. Vape pens come in a variety of shapes and sizes, from small and discreet to large and powerful. Some vape pens are disposable, while others are rechargeable and refillable.

Many vape pens are designed to vaporize a liquid that is often referred to as “vape juice” or “e-juice.” This liquid is typically made from a combination of propylene glycol, vegetable glycerin, and flavorings. Additionally, some vape pens are designed and configured to use one or more type of oils that are contained in a pre-filled cartridge instead.

When it comes to the use of oil cartridges in vape pens, there are a few different types to choose from. Some vape pens use essential oils, which are derived from plants and are often used for aromatherapy purposes. Other vape pens use cannabis oil, which is extracted from the cannabis plant and can contain THC, CBD, or both and are widely used for medicinal purposes. Finally, some vape pens are still used to consume the vapors from an e-juice that contains nicotine. For purposes of this disclosure, “liquid” will refer to e-juice as well as oils.

While the use of vape pens has become increasingly popular over the years, the use of vape pens is not without various problems, particularly with the cartridges used in standard vape pens. For example, some oils have a high viscosity and the concentrate in the cartridge may become stiff when cold. Or, the concentrate may settle to one side of the cartridge and fail to flow to the atomizer correctly, thereby preventing the desired vaporization.

Further, many handheld vaping devices have an issue with oil leaking out of the bottom of the oil cartridge. This leakage occurs primarily due to the prevalence of the relatively thick atomizers in most vape pens and the relatively slow rate of delivery for energy to the oil. For most vape pens, the atomizer must absorb a significant quantity oil prior to creating any vapor from the oil.

Finally, currently cartridge atomizers used in vape pens generally comprise heating elements that are made entirely of ceramic or glass and use a small wire to provide the energy that slowly heats up the elements to create vapor. Ceramic is a poor conductor and the vaporization process is, correspondingly, relatively inefficient. Accordingly, without additional improvements in the state of the art for the cartridges in handheld vaping devices, the process of vaporizing liquid for consumption will continue to be sub-optimal.

### SUMMARY OF THE INVENTION

In accordance with the most preferred embodiments of the present invention, a cartridge for a standard handheld atomizer device is disclosed. The cartridge comprises at least a glass-coated silver conductive element, a beveled glass washer connected to the glass-coated silver conductive element, and an overflow containment storage tank for capturing any oil leaking from the tank holding the oil. In at least one preferred embodiment of the present invention, the conductive element is a glass coated silver bolt, the containment structure is a beveled glass washer, and the liquid substance is an oil. The handheld device can be used in conjunction with a standard vape pen for vaping various oils, including cannabis and tobacco products.

In accordance with other preferred embodiments of the present invention, a method of using a handheld device is provided. The method includes containing a liquid substance in a storage component of the handheld device, transmitting a power source through a conductive element within the storage component, forming particulate matter upon interaction of the power source with the conductive element, preventing or minimizing escape of the liquid substance from the storage component using a containment structure, and maintaining interaction of the liquid substance with a vaporizing unit of the handheld device. The method can further include holding the handheld device, activating the power source to transmit energy through the conductive element, and inhaling the particulate matter formed upon interaction of the power source with the conductive element.

In the most preferred embodiments of the present invention, the conductive element is a glass-coated silver conductor that provides more efficiency in transmitting energy to the oil in a shorter period of time, thereby creating smaller vapor particles due to the combination of a very thin glass coating on the silver conductor. This creates the smallest oil particles possible, thereby increasing bioavailability to facilitate faster and more effective absorption of the vapor.

Additionally, the most preferred embodiments of the present invention will feature a specific assembly which comprises an oil overflow collection chamber in the bottom area of the atomizer chamber, thereby reducing leakage from the bottom of cartridges as the overflow chamber would need to be filled before any oil would escape the cartridge.

### BRIEF DESCRIPTION OF DRAWINGS

The preferred embodiments of the present invention will hereinafter be described in conjunction with the appended drawings, wherein like designations denote like elements, and:

FIG. 1 is a perspective view of a handheld atomizer in accordance with a preferred exemplary embodiment of the present invention;

FIG. 2 is a sectional view of a handheld atomizer configured with a unique cartridge manufactured in accordance with a preferred exemplary embodiment of the present invention;

FIG. 3 is a sectional view of a tank and vapor chamber for a cartridge in accordance with a preferred exemplary embodiment of the present invention, with the cartridge being configured for use in conjunction with a handheld vaping device;

FIG. 4 is a sectional view of a tank and vapor chamber for a cartridge in accordance with an alternative preferred exemplary embodiment of the present invention, with the cartridge being configured for use in conjunction with a handheld vaping device;

FIG. 5 is a sectional view of a portion of a cartridge in accordance with an alternative preferred exemplary embodiment, with the cartridge being configured for use in conjunction with a handheld vaping device;

FIG. 6 is a sectional view of a glass washer assembly for a cartridge designed in accordance with a preferred exemplary embodiment of the present invention, with the cartridge being configured for use in conjunction with a handheld vaping device; and

FIG. 7 is a sectional view of a glass washer assembly placed into a cartridge in accordance with a preferred exemplary embodiment of the present invention, with the cartridge being configured for use with a handheld vaping device.

### DETAILED DESCRIPTION OF THE INVENTION

A cartridge for a handheld atomizer device comprises at least a glass-coated silver conductive element, a beveled glass washer connected to the glass-coated silver conductive element, and an overflow containment storage tank for capturing any oil leaking from the tank holding the oil. In at least one preferred embodiment of the present invention, the conductive element is a glass coated silver bolt, the containment structure is a beveled glass washer, and the liquid substance is an oil. The handheld device can be used in conjunction with a standard vape pen for vaping various oils, including cannabis and tobacco products.

In the most preferred embodiments of the present invention, the cartridge is configured as a 510 thread cartridge. The term “510 thread” refers to the specific type of threading that is commonly used in many vape pens and cartridges. The number 510 simply indicates the thread's dimensions (e.g., 5 mm in diameter with 10 threads per millimeter). This standardized threading allows for compatibility between various components, making it easy to switch between different cartridges and batteries. With the threading for the cartridges of the present invention following industry standards, the cartridges of the present invention are backwards compatible with many existing vape pens.

In at least one preferred exemplary embodiment of the present invention, a cartridge for use in conjunction with a handheld atomizer device for vaping is disclosed. Various handheld vaping devices are well-known to those skilled in the art and the cartridges disclosed herein generally comprise cartridges with a tank for holding the oil to be vaporized, a highly conductive element coated with glass, and an overflow tank for holding any oil that may leak from the body of the cartridge.

The cartridge is used in conjunction with a handheld vaping device, where the vaping device comprises a power source for transmitting energy through the conductive element contained in the cartridge. The energy transmission facilitates various operations of the handheld device, including the vaporization of the oil in the cartridge. The cartridge also comprises a containment structure for holding a portion of the liquid substance that may leak from the cartridge. The containment structure can be a beveled glass washer. The containment structure is configured to catch and contain liquid substance escaping from the cartridge.

The handheld device also comprises a storage component for containing the liquid substance and the conductive element. The liquid substance can be oil. The storage component and the containment structure work in conjunction to maintain interaction of the liquid substance with a vaporizing unit.

In at least one of the preferred embodiments of the present invention, the handheld device further comprises a vaporizing unit for creating particulate matter upon interaction of the oil with the conductive element. The particulate matter most preferably comprises vapor particles that are inhaled by the user.

In at least one of the preferred embodiments of the present invention, the handheld device comprises an atomizer for vaping tobacco products. The atomizer facilitates the conversion of the liquid substance into vapor particles which can be inhaled by a user.

In at least one of the preferred embodiments of the present invention, a method of using a handheld device in conjunction with the unique cartridge design disclosed. The method includes containing a liquid substance in the tank or storage component of the cartridge and transmitting a power source (e.g., battery) through the cartridge conductive element to vaporize the oil contained within the body of the cartridge.

The method further includes forming particulate matter from the oil upon interaction of the energy from power source, transmitted via the conductive element contained within the cartridge. The particulate matter is simply the vapor formed by the vaporization of the oil in the cartridge.

The method also includes preventing escape of the liquid substance from the storage component using the containment structure. The most preferred embodiments of the containment structure comprises a beveled glass washer.

In at least one of the preferred embodiments of the present invention, the conductive element of the cartridge comprises a glass coated silver bolt.

In at least one of the preferred embodiments of the present invention, a glass washer is positioned and configured to prevent the escape of liquid substance (e.g. oil), thereby acting as a catch basin so that oil does not leak from the cartridge. Finally, an overflow containment tank can be positioned within the cartridge to contain any oil that is not vaporized and that escapes the glass washer.

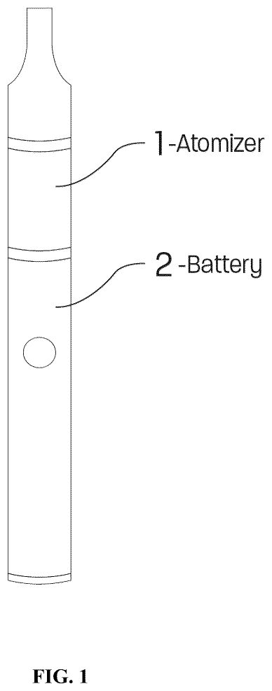

Referring now to FIG. 1, a perspective view of a vape pen 200 containing a cartridge in accordance with a preferred exemplary embodiment of the present invention is depicted. As shown in FIG. 1, vape pen 200 comprises a body 210, with body 210 comprising an atomizer 1 and a battery 2. Atomizer 1 is the portion of vape pen 200 that contains the cartridge with the oil that is atomized for inhalation. Battery 2 is the power or energy source that is electrically connected to atomizer 1, thereby providing the energy necessary to atomize the oil contained in atomizer 1.

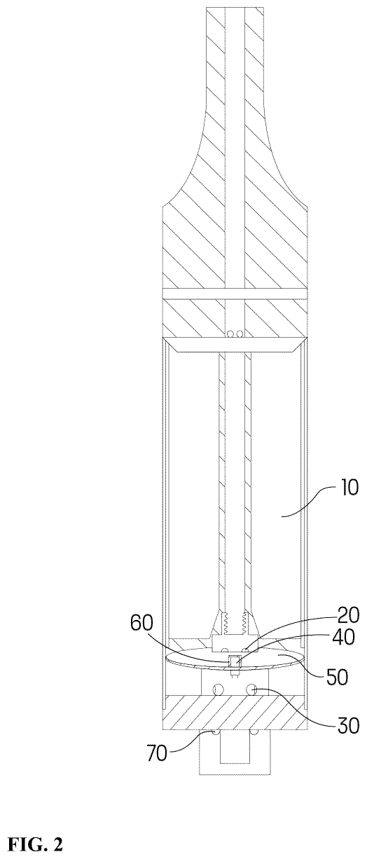

Referring now to FIG. 2, a sectional view of handheld atomizer 200 containing a cartridge manufactured in accordance with a preferred exemplary embodiment of the present invention is depicted. As shown in FIG. 2, the cartridge comprises: a tank 10 for storing the oil to be vaporized; an entry port/extract intake 20; an air entry port 30, an air intake 70; a silver conductor 40; a beveled glass washer 50; and a glass conductor coating 60. Glass coating 60 is a very thin layer of glass covering conductor 40. In the most preferred embodiments of the present invention, glass washer 50 is connected (by sintering or similar method) to glass coating 60 that encapsulates conductor 40, thereby fully isolating conductor 40 with in a glass enclosure.

By covering conductor 40 with glass coating 60, no oil dispensed from tank 10 will ever come into direct contact with conductor 40. This is important because certain oil, after contacting a metal, may develop an unpalatable taste when vaporized.

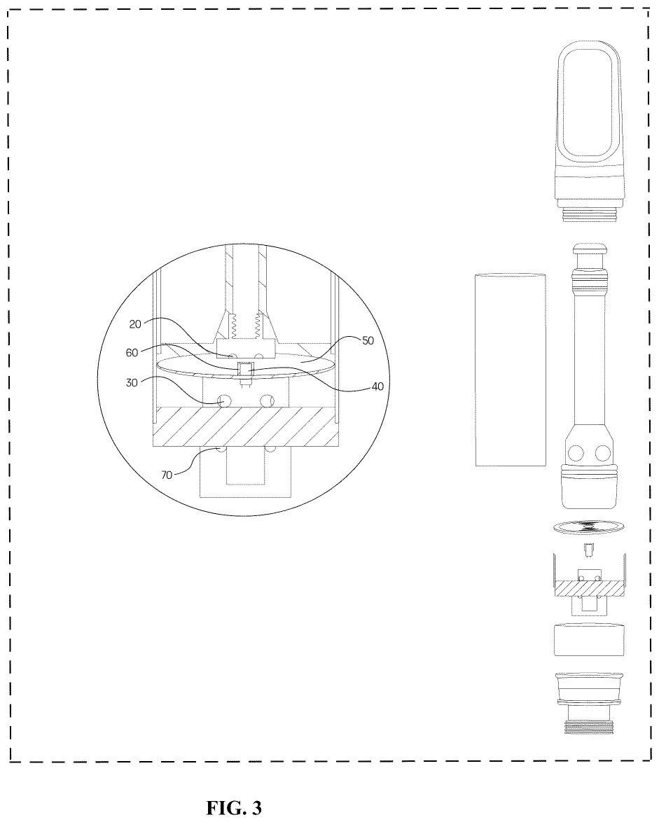

Referring now to FIG. 3, a sectional view of a vapor chamber of a cartridge in a handheld atomizer in accordance with a preferred exemplary embodiment of the present invention is depicted. As shown in FIG. 3, the cartridge comprises: entry port/extract intake 20; air entry port 30; silver conductor 40; beveled glass washer 50; glass coating 60; and air intake 70.

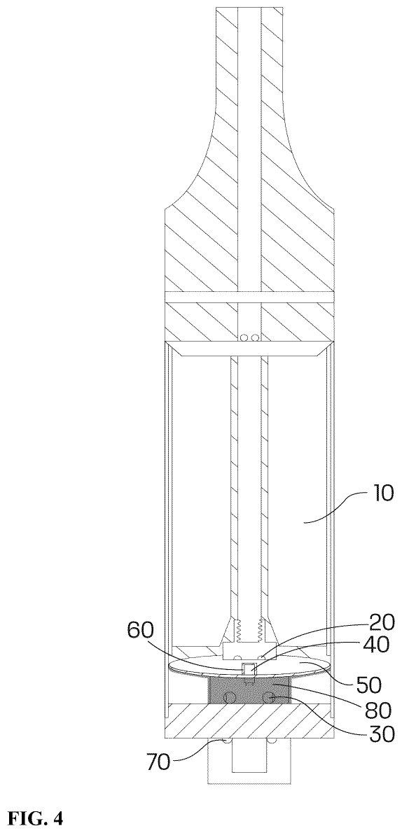

Referring now to FIG. 4, a sectional view of a cartridge positioned in a handheld atomizer in accordance with an alternative preferred exemplary embodiment of the present invention is depicted. As shown in FIG. 4, the cartridge comprises: a tank 10 for storing the oil to be vaporized; an entry port/extract intake 20; an air entry port 30, an air intake 70; a silver conductor 40; a beveled glass washer 50; a glass conductor coating 60; and a glass fixture 80. Glass fixture 80 is a support structure and beveled glass washer 50 rests on glass fixture 80.

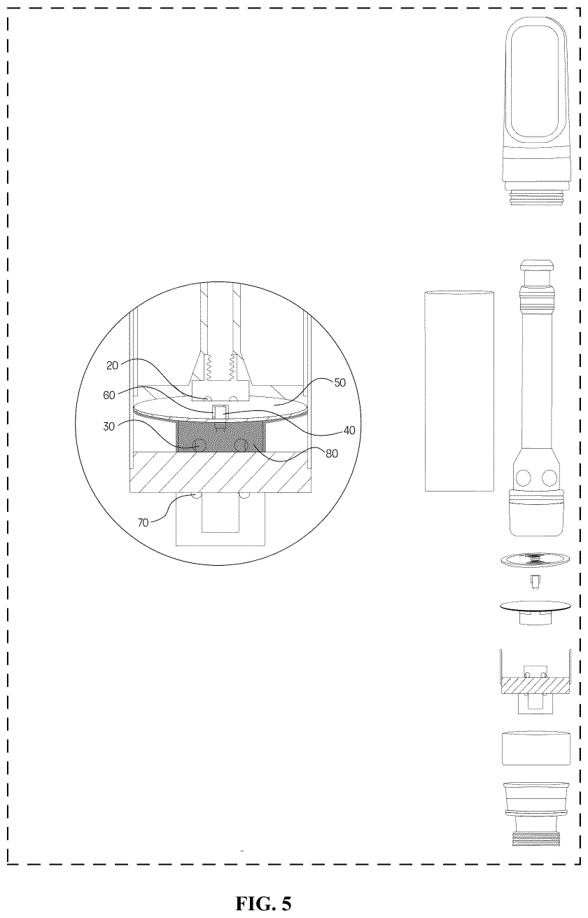

Referring now to FIG. 5, a sectional view of a vapor chamber in a handheld atomizer in accordance with an alternative exemplary embodiment of the present invention is depicted. As shown in FIG. 5, the cartridge comprises: an entry port/extract intake 20; an air entry port 30, an air intake 70; a silver conductor 40; a beveled glass washer 50; a glass conductor coating 60; and a glass fixture 80.

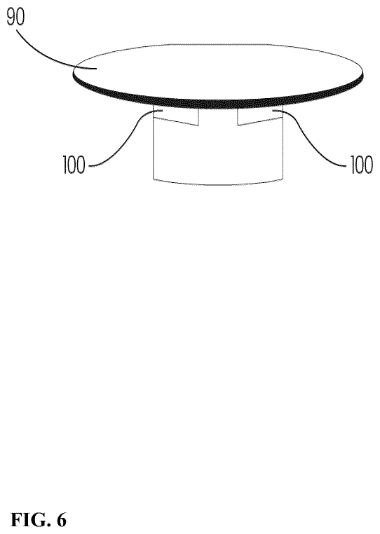

Referring now to FIG. 6, a sectional view of a glass washer assembly contained in a cartridge in accordance with a preferred exemplary embodiment of the present invention is depicted. As shown in FIG. 6, glass bottom fixture 90 rests on air outflow 100.

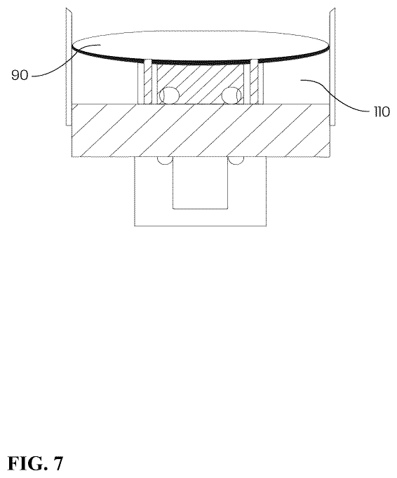

Referring now to FIG. 7, a sectional view of a glass washer assembly in a cartridge in accordance with a preferred exemplary embodiment of the present invention is depicted. As shown in FIG. 7, glass fixture 90 is positioned above overflow storage reservoir 110. As any unvaporized oil spills over bottom glass fixture 90, it will be contained in reservoir 110, thereby reducing or eliminating leakage from the bottom of the cartridge.

Lastly, the terminology used herein is for the purpose of describing particular embodiments only, and is not intended to limit the scope of the present disclosure, which is defined solely by the claims. Accordingly, embodiments of the present disclosure are not limited to those precisely as shown and described.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the disclosed embodiments (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”), provided herein is intended merely to better illuminate the present disclosure and does not pose a limitation on the scope of the embodiments otherwise claimed. No language in the present specification should be construed as indicating any non-claimed element essential to the practice of the disclosed embodiments.

1. A cartridge for use in conjunction with a handheld vaping device, the cartridge comprising:
A body;
a tank contained with the cartridge body, the tank being configured to store a liquid substance for vaporization;
a conductive element coated with a material, the conductive element being configured to contact the liquid substance;
a containment structure configured to contain at least a portion of the liquid substance that is not vaporized; and
a storage reservoir configured to contain at least a portion of the liquid substance that is not vaporized.

2. The handheld device of claim 1, wherein the conductive element comprises a glass-coated silver conductive element.

3. The handheld device of claim 1, wherein the containment structure is a beveled glass washer.

4. The handheld device of claim 1, wherein the liquid substance is oil.

5. The handheld device of claim 1, wherein the material coating the conductive element comprises glass.

6. The handheld device of claim 1, wherein the cartridge is positioned within the handheld vaping device and the liquid substance comprises oil that is vaporized by the conductive element.

7. The handheld device of claim 1, wherein the containment structure functions to prevent escape of said liquid substance from said storage component.

8. The handheld device of claim 1, wherein the containment structure is configured to constrain the liquid substance so as to provide maximum contact exposure of the oil with the conductive element.

9. A method of using a handheld device, comprising:
containing a liquid substance in a storage component of the handheld device;
transmitting a power source through a glass-coated conductive element within the storage component, the conductive element being in contact with the liquid substance;
forming particulate matter upon energization of the conductive element and contact between the conductive element and the liquid substance;
preventing escape of the liquid substance from the storage component using a containment structure; maintaining interaction of said liquid substance with a vaporizing unit of said handheld device.

10. The method of claim 9, wherein the conductive element is a glass-coated silver conductor.

11. The method of claim 9, wherein the containment structure is a beveled glass washer.

12. The method of claim 9, wherein the liquid substance is oil.

13. The method of claim 9, wherein the particulate matter is vapor particles.

14. The method of claim 9, wherein the handheld device is an atomizer for vaping cannabis products.

15. The method of claim 9, further comprising the steps of:
holding the handheld device;
activating the power source to transmit energy through the conductive element;
inhaling the particulate matter formed upon interaction of the power source with the conductive element.

16. The method of claim 15, wherein the conductive element is a glass coated silver bolt.

17. The method of claim 15, wherein the containment structure is a beveled glass washer.

18. The method of claim 15, wherein the liquid substance is oil.

19. The method of claim 15, wherein the particulate matter is vapor particles.

20. The method of claim 15, wherein the handheld device is an atomizer for vaping cannabis products.
